(19) United States
(12) Patent Application Publication
(10) Pub. No.: US 2002/0100399 A1
(43) Pub. Date: Aug. 1, 2002

(54) Drop safe

(76) Inventor: Neil M. Young, Downingtown, PA (US)

Correspondence Address: Fish & Richardson P.C., Suite 2800, 45 Rockefeller Plaza, New York, NY, 10111, US

(21) Appl. No.: 10/046,845

(22) Filed: Jan. 14, 2002

Related U.S. Application Data
(60) Provisional application No. 60/264,961, filed on Jan. 30, 2001.

(51) Int. Cl. G07G 5/00

(52) U.S. Cl. 109/24.1

(57) ABSTRACT

A drop safe includes a housing defining an interior bill acceptor portion and a cashbox portion, a lockable first door connected to the housing for accessing the bill acceptor portion, and a lockable second door connected to the housing for accessing the cashbox portion. In an implementation, the first door covers the second door when the first door is in a closed position.

This application claims priority of U.S. Provisional Application No. 60/264,961 filed on Jan. 30, 2001.

### BACKGROUND OF THE INVENTION

The invention relates in general to a drop safe configuration that includes at least two doors to provide separate access to an inner portion that includes a bill acceptor and to another inner portion that includes the cashbox.

Convenience stores, gas stations and the like often receive a significant volume of cash or currency and need to secure the cash from robbery or theft on the premises. Many such outlets contract with an armored-car service to periodically pick up the cash for transport to a central location where the currency is counted, and then deposited in a bank account for the benefit of the merchant. The reduced amount of cash remaining at the retail facility presents a less-inviting target for robbers, and reduces the amount of money at risk in case of a robbery.

Many merchants prefer maintaining a relatively secure location on the premises for storing currency while awaiting pickup or deposit. Having cash on hand is particularly desirable for facilities such as convenience stores, gas stations, and the like that have little or no staff apart from the cashiers on the premises. Cashiers typically close out their cash registers or other point-of-sale terminals at the end of their shifts, and usually transfer the receipts to the secure location for subsequent pickup or deposit. However, cashiers often are encouraged or instructed to remove currency from their cash drawers from time to time during a shift, to reduce the amount of money at risk if a robbery occurs. In most retail facilities, the cash receipts are segregated by cashier, so as to maintain personal accountability for the cash removed from the cash drawers.

Drop safes are known in the art for facilitating the transfer of cash to a secure location for temporary storage. A drop safe typically has a slot into which the cashiers may insert an envelope containing currency removed from the cash drawers during or at the end of each shift. The combination or key required for opening the drop safe is typically not available to anyone other than security personnel, such as the armored-car service personnel. A robber thus can only steal the currency in the cash drawers. Such safes require each cashier to place receipts in a separate envelope, preferably marked with the cashier's name, before placing the currency into the slot of the drop safe. The cashier or store manager also must keep a log showing the amounts deposited and the name of the person making each deposit. Such procedures are time-consuming and thus may not be followed, especially by cashiers who must serve a steady volume of customers.

Other conventional drop safes include electronic bill acceptors for purposes of inspecting cash presented for deposit, for accepting and counting the bills that meet or exceed a predetermined quality threshold, and for rejecting bills that fall below the quality threshold. Such drop safes are capable of maintaining a running tally of acceptable currency, and can identify each person utilizing the drop safe and the time of deposit. Access to the bill acceptors and to the cashbox is through one door that only a security person can open. Thus, if the bill acceptor entryway or transport mechanism becomes blocked or jammed, either by a worn bill or debris, a security person must be summoned to open the door to allow a maintenance person to clear the debris from the interior of the acceptor. Such armored car special collection requests can become expensive if a bill acceptor continually becomes jammed during use. Thus, bill acceptors having low jam rates, which are expensive, are often using in such drop safes to minimize the number of times a security person must be summoned.

### SUMMARY OF THE INVENTION

Presented is a drop safe including a housing that defines an interior bill acceptor portion and a cashbox portion. A lockable first door is connected to the housing and provides access to the bill acceptor portion. A lockable second door is connected to the housing and provides access to the cashbox portion.

An implementation of the invention may include one or more of the following features. The first door may cover the second door when the first door is in a closed position. A first lock may be attached to the first door and a second lock may be attached to the second door, and the locks are different from each other.

The drop safe configuration according to the invention utilizes a first door to access the bill acceptors and a separate, second door to access the cashbox portion of the drop safe housing. Such a configuration allows the functions of providing periodic maintenance procedures and of removing debris or jammed bills from the bill acceptor to be segregated from the function of collecting the currency in the cashbox. Consequently, a less skilled operator such as a cashier can provide bill acceptor maintenance functions without requiring the presence of a security person to guard the cashbox. Further, a highly skilled operator can access the bill acceptor in order to update software or replace hardware portions of the unit without requiring security personnel to oversee the task, so that operational improvements can be made inexpensively. Further, bill acceptors having slightly higher jam rates can be used because cashiers can easily service the bill acceptors if a jam occurs without requiring security personnel or a store manager to come to the location to either make a collection and/or to guard the cashbox.

### BRIEF DESCRIPTION OF THE DRAWINGS

FIG. 1 illustrates an embodiment of a drop safe according to the invention.

FIG. 2 illustrates another embodiment of a drop safe according to the invention.

Like reference numbers denote like elements in the drawings.

### DETAILED DESCRIPTION

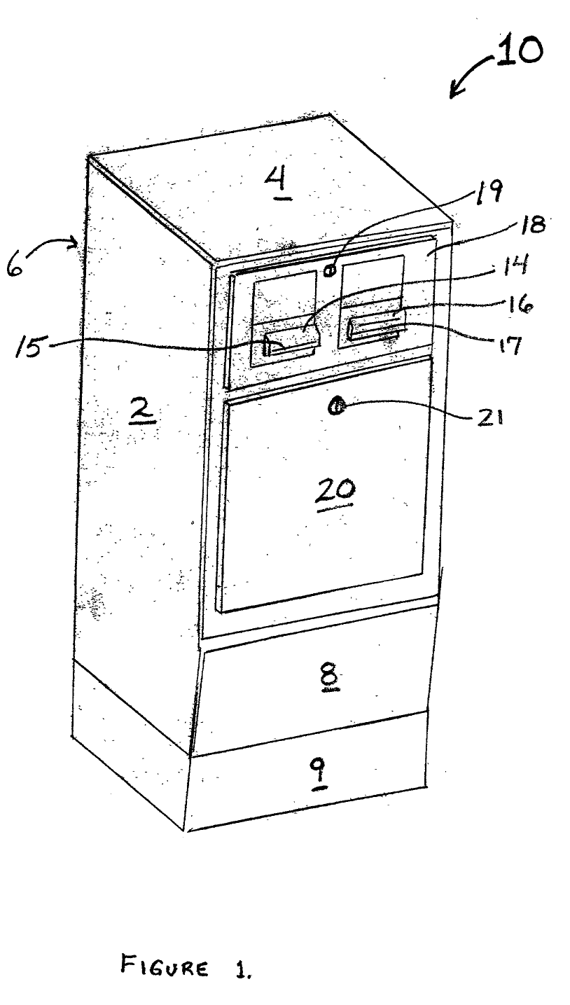

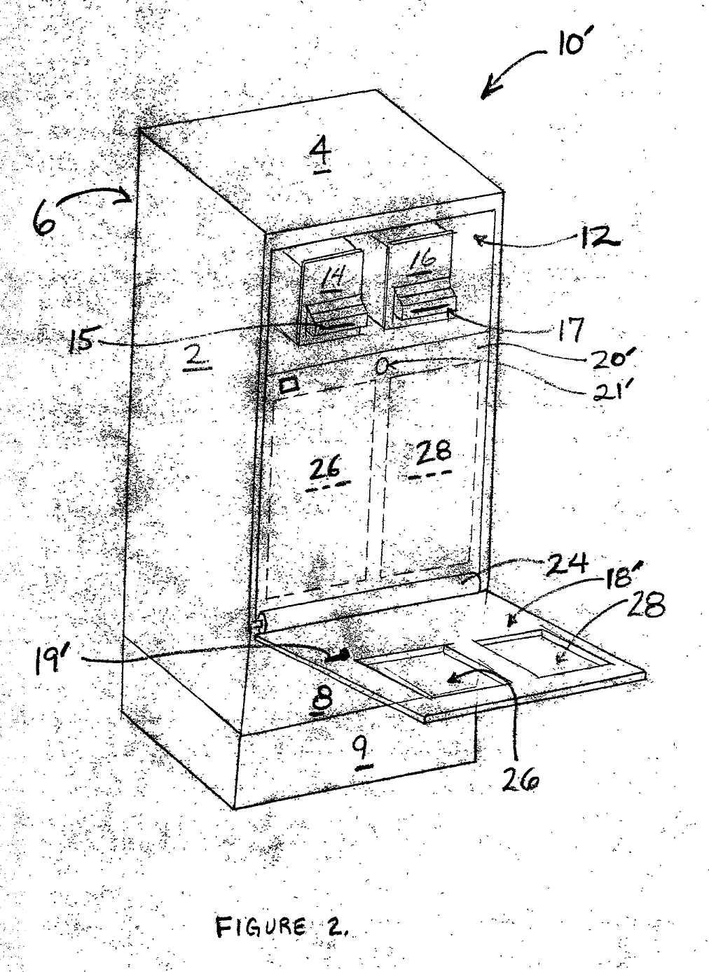

FIG. 1 illustrates a drop safe 10 that includes an outer housing having side panels 2 on the left and right sides, a top panel 4 and a back panel 6. The side panels 2, top panel 4, back panel 6 and a lower front panel 8, that extends upwardly from the bottom of the drop safe 10, define an upper interior portion 12 (see FIG. 2) and a lower interior portion (not shown) within the drop safe. The drop safe 10 is shown supported on a separate base 9 that is elevated above, and securely anchored to, the floor or other support structure. The height of the base 9 can be selected to fit beneath a counter or some other store fixture or the like, and the drop safe may be bolted or otherwise fastened to the base.

In FIG. 1, the drop safe includes two bill acceptors 14 and 16 which may be physically connected to a bracket or other support structure (not shown) within the upper interior portion 12 of the housing. The bill acceptors typically include banknote sensors, a transport mechanism and control circuitry to validate and denominate currency such as bills, paper currency, checks, security documents and the like. Some bill acceptors are configured to mate with a lockable, removable cassette that stores accepted bills, while other bill acceptors merely transport currency through a passageway to an exit slot where the accepted bills fall under the influence of gravity into a cashbox or storage container. The bill acceptors may be of modular design, and thus may be easy to maintain and/or replace if a bill becomes jammed therein. Many different types of bill acceptors are known, including bill acceptor models manufactured by the assignee of the present case, but are outside the scope of the invention and thus will not be discussed in any further detail herein.

The drop safe 10 includes a first door assembly 18 that occupies substantially all of the space in the front top portion of the housing, and prevents unauthorized access to the bill acceptors. The door assembly 18 includes two cut-out sections for permitting at least the bill entryways 15, 17 of the bill acceptors to protrude therethrough, and a hinge mechanism (not shown) for opening the door. A lock 19 may be provided for insertion of a key to open the door 18. Other types of known locking devices, such as key pad electronic locks, touch memory locks, mechanical combination locks and the like, could be used. The lock 19 may be located elsewhere than the position shown on the door 18, as long as it operates to secure the door when locked. If the drop safe is used in a convenience store, for example, the upper door may include a “cashier's lock” so that a cashier can access the bill acceptor area without having to call an armored car company to send a security guard to make an unscheduled or “special” collection. Such unscheduled collection events increase the cost of doing business for a merchant, and thus the capability to have a cashier or other store employee access the bill acceptors is beneficial to the business owner.

A second door assembly 20 occupies substantially all the space between the lower front panel 8 and the first door assembly 18. The second door assembly includes a separate lock 21, different from lock 19 of the first door assembly 18. The key or combination of the second lock is held only by security personnel or other authorized person. Unlocking the second lock 21 to open the second door permits the authorized person, such as an armored-car security guard, to access the cashboxes (not shown) located behind the door within the lower interior portion of the housing. Therefore, if one of the bill acceptors 14, 16 needs maintenance or repairs, a store employee can access just the upper interior portion of the housing herself by opening the door 18 without requiring any security personnel to be present. Since the cashboxes are not accessible by the store employee, there is no need for a security guard to be present.

In the drop box configuration of FIG. 1, the first lock 19 may be operated with a cashier's key. The second lock 21 may be operated by a separate security key. Alternately, the second lock may be configured in much the same way as a bank safe deposit box, wherein both the cashier's key plus a security guard's key must be used simultaneously to open the lock. Many other permutations of different types of locks could also be used.

FIG. 2 illustrates another implementation of a drop box 10′ having a housing that is substantially the same as that described above with regard to FIG. 1. In FIG. 2 a first door assembly 18′ is shown in an open, unlocked position so that an employee or service personnel can access the bill acceptors 14, 16 residing in the upper inner portion 12 of the housing. The first door assembly 18′ includes a hinge element 24 and cut-out portions 26, 28 that permit at least the bill entryway portions 15, 17 of the bill acceptors to protrude therethrough when the first door is in its closed position. A lock 19′ may also be provided for securing the first door assembly to a bracket, frame or other support structure within the housing.

In FIG. 2, the second door assembly 20′ is shown in its closed position. Behind the door assembly 20′ are two cashboxes 26, 28 shown in dotted-line outline. The second door assembly 20′ utilizes the same hinge element 24 as door 18′, and includes a lock 21′, that is different from the lock 19′. The door 20′ cannot be opened until unlocked by a security person. In this configuration, the second door assembly 20′ cannot even be accessed unless the first door assembly 18′ is unlocked and opened as shown. This structure therefore adds another layer of security since two doors must be unlocked to gain access to the cashboxes.

It should be understood that various modifications may be made without departing from the spirit and scope of the invention. For example, although an implementation of the invention describes first and second doors that use a common hinge element and swing open from top to bottom, the doors can be designed to swing open from different hinge elements, and may open from the side or bottom. In addition, one door could swing open in a different manner than the other door. Yet further, many different types of lock arrangements are contemplated. Consequently, other embodiments are within the scope of the following claims.

What is claimed is:

1. A drop safe comprising:
a housing defining an interior bill acceptor portion and a cashbox portion;
a lockable first door connected to the housing for accessing the bill acceptor portion; and
a lockable second door connected to the housing for accessing the cashbox portion.

2. The apparatus of claim 1 wherein the first door covers the second door when the first door is in a closed position.

3. The apparatus of claim 1 further comprising a first lock attached to the first door and a second lock attached to the second door, wherein the first and second locks are different.

4. A drop safe comprising:
a housing defining an interior bill acceptor portion and a cashbox portion;
a first door connected to the housing for accessing the bill acceptor portion; and
a second door connected to the housing for accessing the cashbox portion.

5. The apparatus of claim 4 wherein at least one of the doors is lockable.

6. The apparatus of claim 4 further comprising a lock on the second door.

7. The apparatus of claim 4 further comprising a first lock attached to the first door and a second lock attached to the second door.

8. The apparatus of claim 4 wherein the first door covers the second door when the first door is in a closed position.
